(19) United States
(12) Patent Application Publication
(10) Pub. No.: US 2008/0074772 A1
(43) Pub. Date: Mar. 27, 2008

(54) Magnetic recording and reproducing device

(75) Inventors: Nobuyoshi Yamasaki, Kawasaki (JP); Yuichiro Yamazaki, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/986,179

(22) Filed: Nov. 20, 2007

Related U.S. Application Data
(63) Continuation of application No. PCT/JP05/09467, filed on May 24, 2005.

(51) Int. Cl. G11B 27/36; G11B 5/09; G11B 5/02; G11B 21/02

(52) U.S. Cl. 360/31; 360/53; 360/75; 360/68

(57) ABSTRACT

A magnetic recording and reproducing device comprising a magnetic head for writing data to a storage medium by write current, and a computing unit that has a program area for determining a value indicating a signal quality of data read from the recording medium, and a memory area for holding a first write current value which is a predetermined optimum value and a second write current value which is lower than the first write current value.

### CROSS REFERENCE TO RELATED APPLICATIONS

This application is a continuation of International Application No. PCT/JP2005/9467, filed on May 24, 2005, now pending, herein incorporated by reference.

### TECHNICAL FIELD

The present invention relates to a method for evaluating deterioration of a magnetic head, and a magnetic recording and reproducing devices for evaluating the deterioration of a magnetic head.

### BACKGROUND ART

A magnetic recording and reproducing device records and reproduces information by rotating a magnetic disk formed of a ferromagnetic substance, and scanning a magnetic head on the magnetic disk, and is gradually used as an auxiliary storage device of a computer.

For recording, the magnetic recording and reproducing device supplies write current, which inverts based on write data, to the magnetic head. If a characteristic failure or a connected resistor deterioration occurs at this time in a write current drive circuit, suspension, magnetic head or area connecting each part, an appropriate reversal of magnetization is not generated in the recording medium. If an appropriate reversal of magnetization is not generated, this is detected during reproduction, and an increase in the error rate and loss of data occur.

To avoid such a situation, the write operation is guaranteed by performing reading after the write operation to confirm the writing. Also in a write current drive circuit, a circuit to detect the disconnection of a signal line and a mechanism to detect whether the write current drive circuit is operating normally are installed.

The technology disclosed in Patent Document 1 concerns repeat of writing while changing the write current to confirm writing. The technology of Patent Document 1 is for confirming the operation of the head abnormality detection circuit, and is not for detecting an abnormality of the magnetic head by reading the written data.

Patent Document 1: Japanese Patent Application Laid-Open No. H11-016131

### DISCLOSURE OF THE INVENTION

With this technology, however, it cannot be judged whether the write current to be used for writing is appropriate or not. Even if an appropriate write current is set, normal writing cannot be confirmed if a failure of the circuit system or a deterioration of the magnetic head occurs.

With the foregoing in view, it is an object of the present invention to provide a magnetic recording and reproducing device which can detect an abnormality of the magnetic head by reading write data and monitoring the read data while confirming that the write current is an optimum value.

To solve the above problems, a first aspect of the present invention provides a magnetic recording and reproducing device, having a magnetic head which writes data to a storage medium based on write current, and a computing unit which has a program area for determining a value indicating a signal quality of data read from the recording medium, and a memory area for holding a first write current value which is a predetermined optimum value, and a second write current value which is lower than the first write current value, wherein the magnetic head writes data to the recording medium, based on the first and second write current values, which are set by the computing unit, and reads the data written in the recording medium, and the computing unit sets the first and second write current values for the write current to be supplied via the magnetic head, determines values to indicate a first and second signal qualities corresponding to the data that is read by the magnetic head respectively, compares the value indicating the first signal quality with the value indicating the second signal quality, and judges that the magnetic head has no problem if the value indicating the first signal quality is lower than the value indicating the second signal quality.

In the first aspect of the present invention, it is preferable that the memory area of the computing unit holds a threshold of the value indicating the signal quality of data, and the computing unit compares the value indicating the first signal quality with the threshold of the value indicating the signal quality, and judges that the magnetic head has a problem if the threshold of the value indicating the signal quality is lower than the value indicating the first signal quality.

In the first aspect of the present invention, it is also preferable that the memory area of the computing unit further holds the value indicating the first signal quality which is determined previously, and the computing unit sets the first write current value for the write current to be supplied via the magnetic head after every predetermined interval, determines a value indicating the first signal quality corresponding to the data which is read by the magnetic head, compares the determined value indicating the first signal quality with the value indicating the first signal quality which is previously determined, and judges that the magnetic head has no problem if the determined value indicating the first signal quality does not changed from the value indicating the first signal quality which is previously determined.

In the first aspect of the present invention, it is also preferable that the computing unit sets the first and second write current values for the write current to be supplied via the magnetic head when power is turned ON, and determines the values to indicate the first and second signal qualities corresponding to the data read by the magnetic head respectively.

In the first aspect of the present invention, it is also preferable that the magnetic recording and reproducing device further has a temperature sensor, wherein the temperature sensor measures an environmental temperature and supplies the measured environmental temperature to the computing unit, and the computing unit changes the first write current value and the second write current value based on the supplied environmental temperature.

In the first aspect of the present invention, it is also preferable that the magnetic recording and reproducing device further has a temperature sensor, wherein the temperature sensor measures an environmental temperature and supplies the measured environmental temperature to the computing unit, and the computing unit stores the threshold of the value indicating the signal quality for each environmental temperature in the memory area, and determines the threshold of the value indicating the signal quality for comparing with the determined value indicating the signal quality, based on the environmental temperature supplied from the temperature sensor.

In the first aspect of the present invention, it is also preferable that a plurality of magnetic heads exist, and the computing unit compares the value indicating the first signal quality with the value indicating the second signal quality for each of the magnetic heads.

In the first aspect of the present invention, it is also preferable that a plurality of magnetic heads exist, and the computing unit holds the threshold of the value indicating the signal quality for each of the magnetic heads in the memory area.

A second aspect of the present invention provides a defective head detection method in a magnetic recording and reproducing device having a magnetic head for writing data to a storage medium based on write current, and a computing unit that has a program area for determining a value indicating a signal quality of data read from the recording medium and a memory area for holding a first write current value which is a predetermined optimum value and a second write current value which is lower than the first write current value, comprising the steps of: a first step of setting the first write current value for the write current to be supplied via the magnetic head, writing data to the recording medium, reading the data written in the recording medium, and determining a value indicating a first signal quality of the read data; a second step of setting the second write current value for the write current to be supplied via the magnetic head, writing data to the recording medium, reading the data written in the recording medium, and determining a value indicating a second signal quality of the read data; a comparison step of comparing the value indicating the first signal quality with the value indicating the second signal quality; and judgment step of judging that the magnetic head has no problem if the value indicating the first signal quality is lower than the value indicating the second signal quality.

In the second aspect of the present invention, it is preferable that the memory area of the computing unit holds a threshold of the value indicating the signal quality of data, further comprising the steps of: a threshold comparison step of comparing the value indicating the first signal quality with a threshold of the value indicating the signal quality; and a threshold judgment step of judging that the magnetic head has a problem if the threshold of the value indicating the signal quality is lower than the value indicating the first signal quality.

In the second aspect of the present invention, it is also preferable that the memory area of the computing unit holds the value indicating the first signal quality which is previously determined, further comprising the steps of: a periodic comparison step of setting the first write current value for the write current to be supplied via the magnetic head after every predetermined time interval, determining a value indicating a first signal quality corresponding to the data which is read by the magnetic head, and comparing the determined value indicating the first signal quality with the value indicating the first signal quality which is previously determined; and a periodic judgment step of judging that the magnetic head has no problem if the determined value indicating the first signal quality has not changed from the value to indicate the first signal quality which is previously determined.

In the second aspect of the present invention, it is also preferable that the computing unit executes the comparison step when power is turned ON.

In the second aspect of the present invention, it is also preferable that the magnetic recording and reproducing device further has a temperature sensor, comprising the steps of: measuring an environmental temperature and supplying the measured environmental temperature to the computing unit by the temperature sensor, and changing the first write current value and the second write current value based on the supplied environmental temperature by the computing unit.

In the second aspect of the present invention, it is also preferable that the magnetic recording and reproducing device further has a temperature sensor, comprising the steps of: measuring an environmental temperature and supplying the measured environmental temperature to the computing unit by the temperature unit, and storing the threshold of the value indicating the signal quality, for each environmental temperature, in the memory area, and determining the threshold of the value indicating the signal quality for comparing with the determined value indicating the signal quality, based on the environmental temperature supplied from the temperature sensor.

In the second aspect of the present invention, it is also preferable that a plurality of the magnetic heads exist, and the computing unit compares the value indicating the first signal quality with the value indicating the second signal quality for each of the magnetic heads.

In the second aspect of the present invention, it is also preferable that a plurality of magnetic heads exist, and the computing unit holds in the memory area the threshold of the value indicating the signal quality for each of the magnetic heads.

The magnetic recording and reproducing device of the present invention detects an abnormality of the magnetic head by writing data while changing write current, reading the written data, and determining a value indicating a signal quality of the read data. By this, the reliability of data written in the magnetic recording and reproducing device can be increased.

### BRIEF DESCRIPTION OF THE DRAWINGS

FIG. 1 is a block diagram depicting a magnetic recording and reproducing device according to an embodiment of the present invention;

FIG. 2A is a flow chart depicting a judgment of the deterioration of a magnetic head according to the present invention; and

FIG. 2B is a flow chart depicting a judgment of the deterioration of a magnetic head according to the present embodiment.

### BEST MODE FOR CARRYING OUT THE INVENTION

Embodiments of the present invention will now be described with reference to the drawings. The technical scope of the present invention, however, is not limited to these embodiments, but includes matters stated in the claims and equivalents thereof.

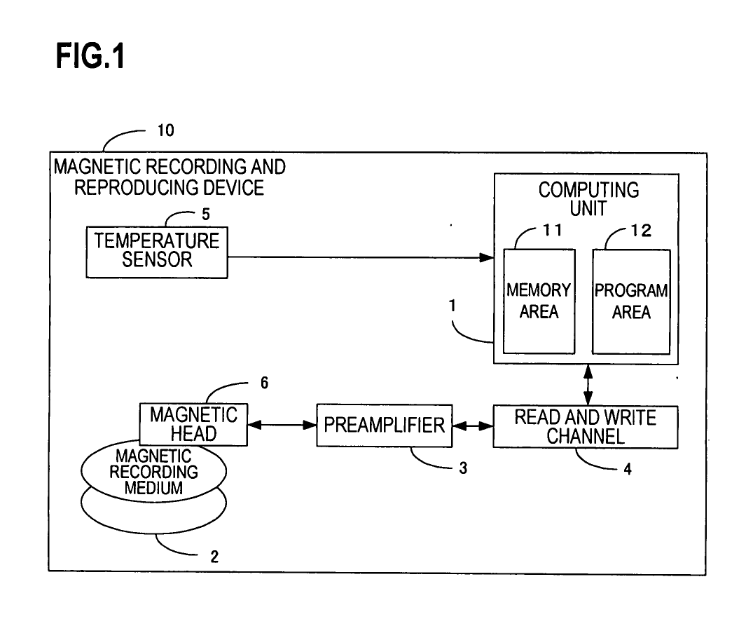

FIG. 1 is a block diagram depicting a magnetic recording and reproducing device according to the present embodiment. The magnetic recording and reproducing device 10 of the present embodiment is comprised of a computing unit 1 for controlling the entire magnetic recording and reproducing device, a read and write channel 4 for modulating and demodulating write and read data, a preamplifier 3 for amplifying a write signal and a read signal, a magnetic recording medium 2 where data is recorded, a temperature sensor 5 for supplying temperature information to the computing unit 1, and a magnetic head 6 for scanning the magnetic recording medium 2. There are a plurality of magnetic heads 6, although this is not illustrated, and each of them scans the magnetic recording medium 2 respectively. The computing unit 1 has a memory 11 for holding an optimum write current value, and a program area 12 for determining a value to indicate signal quality from data read from the magnetic recording medium 2.

In normal data writing, the magnetic recording and reproducing device 10 receives data for writing and an address from a host computer connected to the magnetic recording and reproducing device 10, confirms a position of the magnetic head 6 by servo information on the magnetic recording medium 2, and writes the write data on a target address via the read and write channel 3, preamplifier 4 and magnetic head 6.

In normal data reading, the magnetic recording and reproducing device 10 receives an address from the host computer, confirms a position of the magnetic head 6 by servo information on the magnetic recording medium 2, and reads the data on the target address. The read data signal is amplified by the preamplifier 3, and is demodulated in the read and write channel 4.

Now defective head detection will be described.

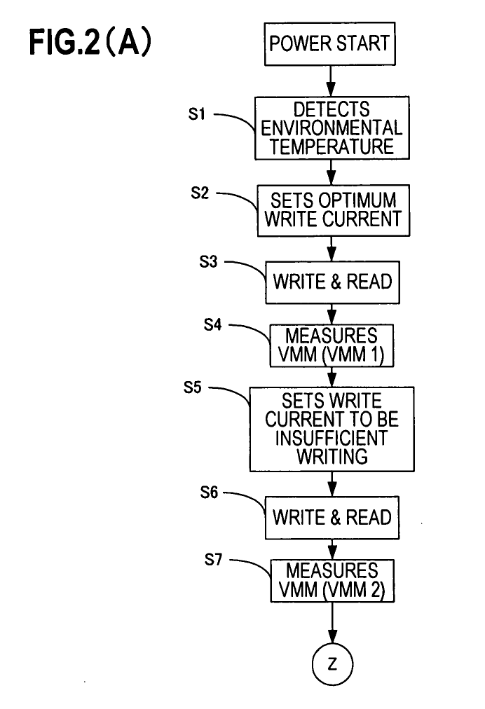

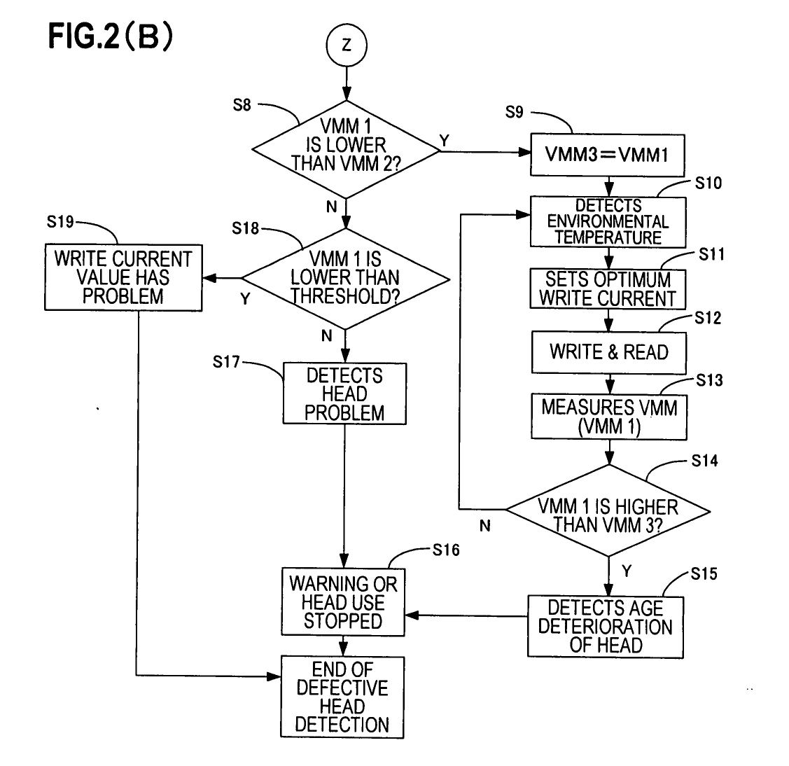

FIG. 2 is a flow chart depicting a judgment of the deterioration of the magnetic head according to the present embodiment. In the present embodiment, the defective head detection is started when power is turned ON. This, however, may be started by a user, or started periodically.

When detection is started, the temperature sensor 5 measures an environmental temperature, and supplies the environmental temperature to the computing unit 1 (step S1). Then an optimum write current value at the measured environmental temperature is fetched from the memory area 11 of the computing unit 1, and is set (step S2). Here an optimum write current value has been stored for each magnetic head 6 to be used. The optimum write current value of the magnetic head is determined in advance based on experiment, for example, and is stored in the memory area 11 of the computing unit 1. Then data is written to and read from the magnetic storage medium 2 (step S3). Then a value to indicate a signal quality of the read data is determined by the program area 12 of the computing unit 1 (step S4). The determined value to indicate the signal quality is stored in the memory area 11 of the computing unit 1.

The value to indicate the signal quality here is specifically a value to indicate such signal quality as a VMM (Viterbi Metric Margin), ER (Error rate) and S/N (Signal-to-Noise ratio). The present embodiment will be described using VMM.

In the magnetic recording field, the Viterbi decoding method is widely used as a method for judging the presence of an error in received data. The Viterbi decoding method is a decoding method in which an analytical value and actually received data are compared for a path of 0/1 continuous data, and a most likely code is determined as a read value (maximum likelihood decoding). VMM has a function developed as a method for measuring signal quality during Viterbi decoding, where a difference (margin) between the path of the received data and a path closest to the path is determined, and the number of cases when the difference is smaller than a threshold are counted.

Referring back to FIG. 2, after step S4, a write current value to be insufficient writing, which is set about 10 to 20 milliampere lower than the optimum write current value at the measured environmental temperature, is fetched from the memory area 11 of the computing unit 1, and is set (step S5). In this case, the write current value to be insufficient writing has been set for each magnetic head 6 to be used. Then data is written to and read from the magnetic storage medium 2 (step S6). Then a value to indicate the signal quality of the read data is determined in the program area 12 of the computing unit 1 (step S7).

The VMM 1 determined in step S4 and the VMM 2 determined in step S7 are compared, and if the value of the VMM 1 is lower, it is judged that the magnetic head 6 and the write current value have no problems (step S8), and processing advances to step S9. If the VMM 1 is higher than VMM 2, then it is possible that the magnetic head 6 or the optimum write current value has problems, so processing advances to step S18.

In step S18, the threshold of the VMM which has been stored in the memory area 11 of the computing unit 1, and the VMM 1 determined in step S4, are compared (step S18). In this case, a threshold of the VMM has been stored for each magnetic head 6 to be used and for each environmental temperature. If the VMM 1 is lower than the threshold of the VMM corresponding to the magnetic head 6 to be used and the measured environmental temperature, it is judged that the optimum write current value has problems (step S19), and defective head detection ends.

If the VMM 1 is higher than the threshold of the VMM, on the other hand, it is judged that the magnetic head 6 has problems (step S17), a warning is output, or use of the magnetic head is stopped (step S16), and defective head detection ends.

In Step S8, if the value of the VMM 1 is lower than the VMM 2, it is judged that the magnetic head 6 and the write current value have no problems, and processing advances to step S9. In step S9, the VMM 1, which is a VMM value of the data written with the optimum write current value, is stored in the memory area 11 of the computing unit 1 as VMM 3 (step S9). Then the temperature sensor 5 measures the environmental temperature, and supplies the environmental temperature to the computing unit 1 (step S10). Then an optimum write current value at the measured environmental temperature is fetched from the memory area 11 of the computing unit 1, and is set (step S11). Then the data is written to and read from the magnetic recording medium 2 (step S12). Then the VMM 1, which is a value to indicate the signal quality of the read data, is determined in the program area 12 of the computing unit 1 (step S13).

The determined VMM 1 and the VMM 3 stored in step S9 are compared (step S14), and if the VMM 1 has not been changed from VMM 3, processing returns to step S10 after a predetermined time elapses, and steps S10 to S14 are repeated. If the VMM 1 is higher than the VMM 3, then it is judged that age deterioration of the magnetic head 6 is detected (step S15), a warning is output, or use of the magnetic head is stopped (step S16), and defective head detection ends.

In this way, the magnetic recording and reproducing device of the present invention detects an abnormality of the magnetic head by writing data while changing the write current, reading the written data, and determining a value to indicate the signal quality of the read data. By this, reliability of data written in the magnetic recording and reproducing device can be increased.

### INDUSTRIAL APPLICABILITY

According to the present invention, problems during writing in the magnetic recording and reproducing device can be detected and predicted at an early stage. Also the validity of the write current value, with respect to the change of the environmental temperature, can be confirmed, and reliability can be improved.

1. A magnetic recording and reproducing device, comprising:
a magnetic head which writes data to a storage medium based on write current; and
a computing unit which has a program area for determining a value indicating a signal quality of data read from the recording medium, and a memory area for holding a first write current value which is a predetermined optimum value and a second write current value which is lower than the first write current value, wherein
the magnetic head writes data to the recording medium based on the first and second write current values which are set by the computing unit, and reads the data written in the recording medium, and
the computing unit sets the first and second write current values for the write current to be supplied via the magnetic head, determines values indicating first and second signal qualities corresponding to the data that is read by the magnetic head respectively, compares the value indicating the first signal quality with the value indicating the second signal quality, and judges that the magnetic head has no problem if the value indicating the first signal quality is lower than the value indicating the second signal quality.

2. The magnetic recording and reproducing device according to claim 1, wherein
the memory area of the computing unit holds a threshold of the value indicating a signal quality of data, and
the computing unit compares the value indicating the first signal quality with the threshold of the value indicating the signal quality, and judges that the magnetic head has a problem if the threshold of the value indicating the signal quality is lower than the value indicating the first signal quality.

3. The magnetic recording and reproducing device according to claim 1, wherein
the memory area of the computing unit further holds the value indicating the first signal quality which is determined previously, and
the computing unit sets the first write current value for the write current to be supplied via the magnetic head after every predetermined time interval, determines a value indicating the first signal quality corresponding to the data which is read by the magnetic head, compares the determined value indicating the first signal quality with the value indicating the first signal quality which is previously determined, and judges that the magnetic head has no problem if the determined value indicating the first signal quality does not changed from the value indicating the first signal quality which is previously determined.

4. The magnetic recording and reproducing device according to claim 1, wherein the computing unit sets the first and second write current values for the write current to be supplied via the magnetic head when power is turned ON, and determines values indicating first and second signal qualities corresponding to the data read by the magnetic head respectively.

5. The magnetic recording and reproducing device according to claim 1, further comprising a temperature sensor, wherein
the temperature sensor measures an environmental temperature and supplies the measured environmental temperature to the computing unit, and
the computing unit changes the first write current value and the second write current value based on the supplied environmental temperature.

6. The magnetic recording and reproducing device according to claim 2, further comprising a temperature sensor, wherein
the temperature sensor measures an environmental temperature and supplies the measured environmental temperature to the computing unit, and
the computing unit stores the threshold of the value indicating the signal quality, for each environmental temperature, in the memory area, and determines the threshold of the value indicating the signal quality for comparing with the determined value indicating the signal quality, based on the environmental temperature supplied from the temperature sensor.

7. The magnetic recording and reproducing device according to claim 1, wherein
a plurality of the magnetic heads exist, and
the computing unit compares the value indicating the first signal quality with the value indicating the second signal quality for each of the magnetic heads.

8. The magnetic recording and reproducing device according to claim 2, wherein
a plurality of the magnetic heads exist, and
the computing unit holds the threshold of the value indicating the signal quality for each of the magnetic heads in the memory area.

9. A defective head detection method in a magnetic recording and reproducing device having a magnetic head for writing data to a storage medium based on write current, and a computing unit that has a program area for determining a value indicating a signal quality of data read from the recording medium and a memory area for holding a first write current value which is a predetermined optimum value and a second write current value which is lower than the first write current value, comprising the steps of:
a first step of setting the first write current value for the write current to be supplied via the magnetic head, writing data to the recording medium, reading the data written in the recording medium, and determining a value indicating a first signal quality of the read data;
a second step of setting the second write current value for the write current to be supplied via the magnetic head, writing data to the recording medium, reading the data written in the recording medium, and determining a value indicating a second signal quality of the read data;
a comparison step of comparing the value indicating the first signal quality with the value indicating the second signal quality; and
a judgment step of judging that the magnetic head has no problem if the value indicating the first signal quality is lower than the value indicating the second signal quality.

10. The defective head detection method according to claim 9, wherein the memory area of the computing unit holds a threshold of the value indicating the signal quality of data, further comprising the steps of:
a threshold comparison step of comparing the value indicating the first signal quality with a threshold of the value indicating the signal quality; and
a threshold judgment step of judging that the magnetic head has a problem if the threshold of the value indicating the signal quality is lower than the value indicating the first signal quality.

11. The defective head detection method according to claim 9, wherein the memory area of the computing unit holds the value indicating the first signal quality which is previously determined, further comprising the steps of:
a periodic comparison step of setting the first write current value for the write current to be supplied via the magnetic head after every predetermined time interval, determining a value indicating a first signal quality corresponding to the data which is read by the magnetic head, and comparing the determined value indicating the first signal quality with the value indicating the first signal quality which is previously determined; and
a periodic judgment step of judging that the magnetic head has no problem if the determined value indicating the first signal quality has not changed from the value indicating the first signal quality which is previously determined.

12. The defective head detection method according to claim 9, wherein the computing unit executes the comparison step when power is turned ON.

13. The defective head detection method according to claim 9, wherein the magnetic recording and reproducing device further has a temperature sensor, comprising the steps of:
measuring an environmental temperature and supplying the measured environmental temperature to the computing unit by the temperature sensor, and
changing the first write current value and the second write current value based on the supplied environmental temperature by the computing unit.

14. The defective head detection method according to claim 10, wherein the magnetic recording and reproducing device further has a temperature sensor, comprising the steps of:
measuring an environmental temperature and supplying the measured environmental temperature to the computing unit by the temperature sensor, and
storing the threshold of the value indicating the signal quality, for each environmental temperature, in the memory area, and determining the threshold of the value indicating the signal quality for comparing with the determined value indicating the signal quality, based on the environmental temperature supplied from the temperature sensor, by the computing unit.

15. The defective head detection method according to claim 9, wherein
a plurality of the magnetic heads exist, and
the computing unit compares the value indicating the first signal quality with the value indicating the second signal quality for each of the magnetic heads.

16. The defective head detection method according to claim 10, wherein
a plurality of the magnetic heads exist, and
the computing unit holds in the memory area the threshold of the value indicating the signal quality for each of the magnetic heads.
